(19) United States
(12) Patent Application Publication
(10) Pub. No.: US 2014/0100987 A1
(43) Pub. Date: Apr. 10, 2014

(54) MONITORING A DROP SHIP PROCESS OF A PARTNER

(71) Applicant: INTERNATIONAL BUSINESS MACHINES CORPORATION, Armonk, NY (US)

(72) Inventors: Erik J. BURCKHART, Raleigh, NC (US); Paul A. CONIGLIO, Westport, CT (US); Andrew J. IVORY, Wake Forest, NC (US); Aaron K. SHOOK, Raleigh, NC (US)

(73) Assignee: Intenational Business Machines Corporation, Armonk, NY (US)

(21) Appl. No.: 13/645,704

(22) Filed: Oct. 5, 2012

(51) Int. Cl. G06Q 30/06; G06Q 50/28

(52) U.S. Cl. 705/26.41

(57) ABSTRACT

A method for monitoring a drop ship process may include receiving a drop ship order for an item from a vendor, the item being ordered by a customer of the vendor. The method may also include performing a supplier drop ship process in response to receiving the drop ship order. The method may further include providing a plug point associated with the supplier, the plug point being connectable through an intermediary to an interface, wherein the supplier drop ship process is monitorable through the interface.

### BACKGROUND

Aspects of the present invention relate online shopping or e-commerce and drop shipping and more particularly to a method, system and computer program product for monitoring a drop ship process of a business partner or associate.

In certain business to business relationships, business partners may provide each other access to their respective buyer or supplier portal separate systems for viewing respective inventories. The buyer or supplier then needs to map the inventory information back to other interactions that the supplier and buyer have made and often manually tie the items together. These systems are all independent and lack the ability to give cross partner views and data relating to the transactions a customer may have made with the partners. This becomes increasingly tedious when dealing with a drop ship scenario since the customer interacts with the seller or vendor, who isn't actually shipping the item and thus the customer has no visibility into the system or no means to monitor the supplier's process and determine the status of an order for an item.

Vendor Managed Inventory is an inventory monitoring arrangement where a buyer's inventory system keeps the supplier's inventory up to date. The supplier owns the inventory in the local buyer's store. For example a manufacturer or supplier may own the inventory in a seller's establishment. When products are sold, the seller may update the manufacturer's or supplier's system as to what has been sold. However, this arrangement is a complex integration and not frequently done.

### BRIEF SUMMARY

According to an aspect of the present invention, a method for monitoring a drop ship process may include receiving, by a processor, a drop ship order for an item from a vendor, the item being ordered by a customer of the vendor. The method may also include performing, by the processor, a supplier drop ship process in response to receiving the drop ship order. The method may further include providing a plug point associated with the supplier. The plug point may be connectable through an intermediary to an interface. The supplier drop ship process is monitorable through the interface.

According to an aspect of the present invention, a method for monitoring a drop ship process may include receiving, by a processor, an order for an item from a customer. The method may also include determining, by the processor, if the order for the item is a drop ship order. The method may additionally include transmitting, by the processor, the drop ship order to a drop ship supplier in response to the order for the item being a drop ship order. The method may further include providing an interface associated with the vendor, the interface being coupled by an intermediary to the drop ship supplier, wherein a drop ship process of the drop ship supplier is monitorable through the interface.

According to an aspect of the present invention, a method for monitoring a drop ship process may include providing an intermediary computer system including a processor. The intermediary computer system connects an interface associated with a vendor to a drop ship supplier. A supplier drop ship process is monitorable by at least a customer of the vendor through the interface and the intermediary.

According to another aspect of the present invention, a system for monitoring a drop ship process may include a processor and a module operating on the processor for receiving an order for an item from a customer. The system may also include a module operating on the processor for determining if the order for the item is a drop ship order. The system may additionally include a module operating on the processor for transmitting the drop ship order to a drop ship supplier in response to the order for the item being a drop ship order. The system may further include an interface associated with a vendor. The interface may be coupled by an intermediary to the drop ship supplier. A drop ship process of the drop ship supplier is monitorable through the interface.

According to another aspect of the present invention, a system for monitoring a drop ship process may include a processor and a module operating on the processor for receiving an order for an item from a customer. The system may also include a module operating on the processor for determining if the order for the item is a drop ship order. The system may also include a module operating on the processor for transmitting the drop ship order to a drop ship supplier in response to the order for the item being a drop ship order. The system may additionally include an interface associated with a vendor. The interface may be coupled by an intermediary to the drop ship supplier. A drop ship process of the drop ship supplier is monitorable through the interface.

According to a further aspect of the present invention, a computer program product for monitoring a drop ship process may include a computer readable storage medium having computer readable program code embodied therewith. The computer readable program code may include computer readable program code configured to receive an order for an item from a customer. The computer readable program code may also include computer readable program code configured to determine if the order for the item is a drop ship order. The computer readable program code may additionally include computer readable program code configured to transmit the drop ship order to a drop ship supplier in response to the order for the item being a drop ship order. The computer readable program code may further include computer readable program code configured to provide an interface associated with a vendor. The interface may be coupled by an intermediary to the drop ship supplier. A drop ship process of the drop ship supplier is monitorable through the interface.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a block schematic diagram of an example of a system for monitoring a drop ship process in accordance with an embodiment of the present invention.

FIG. 2 is a flow chart of an example of a method for processing an order for monitoring a drop ship process in accordance with an embodiment of the present invention.

FIG. 3 is a flow chart of an example of a method for monitoring a drop ship process in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

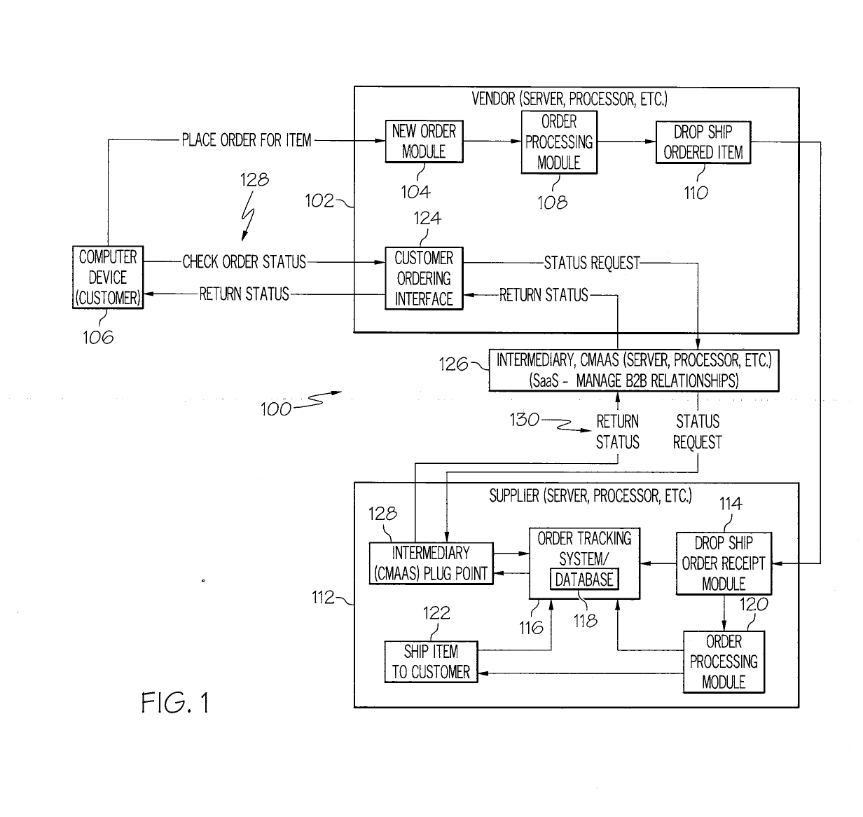

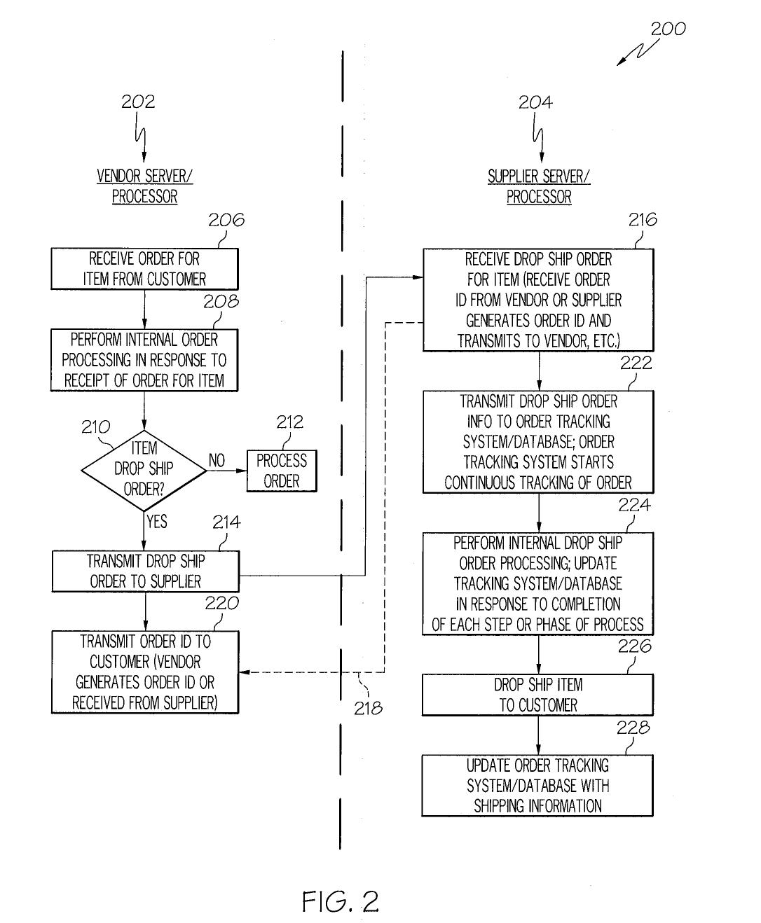

FIG. 1 is a block schematic diagram of an example of a system 100 for monitoring a drop ship process in accordance with an embodiment of the present invention. The system 100 may include a vendor processor 102, server or other computing device associated with a vendor or seller. The vendor processor 102 or server may include a new order module 104. The new order module 104 is adapted to receive an order for an item placed by a customer using a computer device 106. The order may be placed over a network, such as the Internet or other communications network. The vendor processor 102 may also include an order processing module 108 for receiving the order for the item from the new order module 104. The order processing module 104 may be any order processing system. The present invention is applicable to any order processing system and is not dependent upon any particular system. As discussed in more detail with respect to FIG. 2, the order processing module 108 may determine if the order for the item is a drop ship order. A drop ship order is an order for an item that must be provided or shipped by another party other than the vendor or seller, such as a supplier, distributor or manufacturer of the item. As used herein supplier may mean an distributor, manufacturer or any entity that may drop ship an item ordered by a customer through a vendor or seller that is separate or different from the supplier.

The vendor processor 102 or server may also include a drop ship ordered item module 110 for transmitting the drop ship order to a supplier or supplier processor 112 or server in response to the item being an item required to be drop shipped by a party other than the vendor or seller.

The supplier processor 112 may include a drop ship order receipt module 114 to receive the drop ship order for the item from the vendor processor 102. The supplier 112 may also include an order tracking system 116 for tracking the drop ship order process of the supplier 112. The order tracking system 116 may also track the ordered item through the supplier's order completion process and in transit shipment of the ordered item to the customer. The order tracking system 116 may be embodied in the supplier processor 112 or server. The order tracking system 116 may also include a database 118 for storing location information about the drop ship order and the ordered item in supplier order process and shipping process.

The supplier or supplier processor 112 may also include an order processing module 120. The order processing module 120 may perform the internal drop ship order processing of the supplier. The order processing module 120 updates the order tracking system 116 and database 118 during each step or phase of the order completion process. The internal drop ship order processing may be any order processing system or operation. As previously discussed, the present invention may be applicable to any order processing system or operation. In block 122, the item may be shipped to the customer by any appropriate method or means of transport. The order tracking system 116 and database 118 may be updated with the pertinent shipping information in response to the item being shipped to the customer.

An interface 124 or customer ordering interface may be associated with the vendor or vendor processor 102. The interface 124 may be embodied in the vendor processor 102 or server, as illustrated in FIG. 1, or the interface 124 may be embodied in a communications device separate from the vendor processor 102. The interface 124 may be coupled by an intermediary 126 to the drop ship supplier processor 112. A drop ship process of the drop ship supplier 112 may be monitored through the interface 124 and the intermediary 126.

The intermediary 126 may be embodied on a server, processor or other computing device. The intermediary 126 may be embodied as a Community Management as a Service (CMaaS) on the server or Supplier Community Management system. CMaaS may be similar to a Software as a Service (SaaS) environment. CMaaS may provide a variety of business relationships and permit utilization of those relationships to permit on-board and test connections between on-premise systems, sharing of documents and monitoring of processes. CMaaS may be provided as a social network for businesses to connect, communicate and collaborate with one another. CMaaS allows a business to connect to business partners and manage interactions with each of the other businesses. An example of a community management system or service that may be used for the intermediary 126 is RollStream or GXS RollStream. RollStream is a trademark of Rollsteam, Inc. in the United States, other countries or both.

The interface 124 may receive a status request 128 to check the status of the drop ship order from the customer or customer computer device 106. The interface 124 may transmit the status request to the intermediary 126. The intermediary 126 may process the status request and transmit the request to the supplier or supplier processor 112. A plug point 128, intermediary plug point or CMaaS plug point may receive the status request from the intermediary 126. Current order management systems or drop shipping processes do not format data and interactions in a standard way. Accordingly, the plug point 128 interfaces with the CMaaS system or intermediary 126 to collect and normalize data from the supplier 112 and then transmits the data or return status 130 to the customer 106 via the intermediary 126 in a standard format or format that can be interpreted by the customer. For example, the intermediary plug point 128 may be adapted to normalize or transform the data on an electronic data interchange (EDI) format. EDI is a structured transmission format of data between organizations by electronic means. EDI is used to transfer electronic documents or business data from computer system to another computer system, i.e., from one trading partner to another trading partner without human intervention. Accordingly, the plug point 128 is adapted to serve as an interface to the supplier's order management system since the supplier's order management system can contain proprietary data formats and interfaces. The plug point 128 interfaces with the order management system and normalizes the data or transforms the data to an EDI format that is returned to the customer 106. The plug point 128 may be embodied in the supplier processor 112 or server as illustrated in FIG. 1, or in another embodiment, the plug point 128 may be embodied in a device separate from the supplier processor 112.

FIG. 2 is a flow chart of an example of a method 200 for processing an order for monitoring a drop ship process in accordance with an embodiment of the present invention. The exemplary method 200 as shown in FIG. 2 is divided into operations which may be embodied in and performed by a vendor server 202 or processor and a supplier server 204. The method 200 may be embodied in and performed by components of the system 100 in FIG. 1. For example, the vendor server 202 may be the same as the vendor server or processor 102, and the supplier server 204 may be the same as the supplier server or processor 112 in FIG. 1. The invention is not intended to be limited by any particular operation being described as being embodied in or performed by any particular server or processor.

In block 206, an order for an item may be received from a customer or customer computer system. In block 208, internal order processing may be performed in response to receipt of the order for the item. Similar that previously described the embodiments of the present invention are not intended to be limited by any particular internal order processing and the invention may be applicable to any order processing.

In block 210, a determination may be made if the item is an item that needs to be drop shipped and is therefore a drop ship order. If the item is not a drop ship order, the method 200 may advance to block 212. In block 212, the order may be processed for shipping the item to the customer by the vendor or seller.

If the item is not a drop ship order in block 210, the method 200 may advance to block 214. In block 214, the drop ship order for the item is transmitted to the supplier of the item.

In block 216, the drop ship order for the item may be received by the supplier server 204 or processor. In accordance with an embodiment, the vendor server 202 may generate an order identification (ID) which is also transmitted to the supplier server 204. In another embodiment the supplier server 204 may generate an order ID in response to receiving the drop ship order from the vendor server 202. The supplier server 204 may then transmit the order ID to the vendor server 202 as illustrated by the broken line 218.

In block 220, the order ID may be transmitted to the customer by the vendor server 202.

In block 222, the drop ship order information may be transmitted to and order tracking system and may be stored in a database associated with the order tracking system. The order tracking system may start a continuous tracking of the order in response to receiving the drop ship order information including the order ID. The order ID may serve as a pointer into the database to retrieve status information about the drop ship order or the item being ordered. The status information may include location information about where the drop ship order and/or the ordered item are in the supplier's drop ship process.

In block 224, an internal drop ship order processing may be performed. As previously described, the present invention is independent of any particular order processing procedure and may be used with or applied to any type order processing procedure. The order tracking system and database may be updated in response to completion of each step or phase of the drop ship order process.

In block 226, the item may be dropped shipped to the customer in response to the internal drop ship order processing procedure being completed. In block 224, the order tracking system and database may be updated with the shipping information.

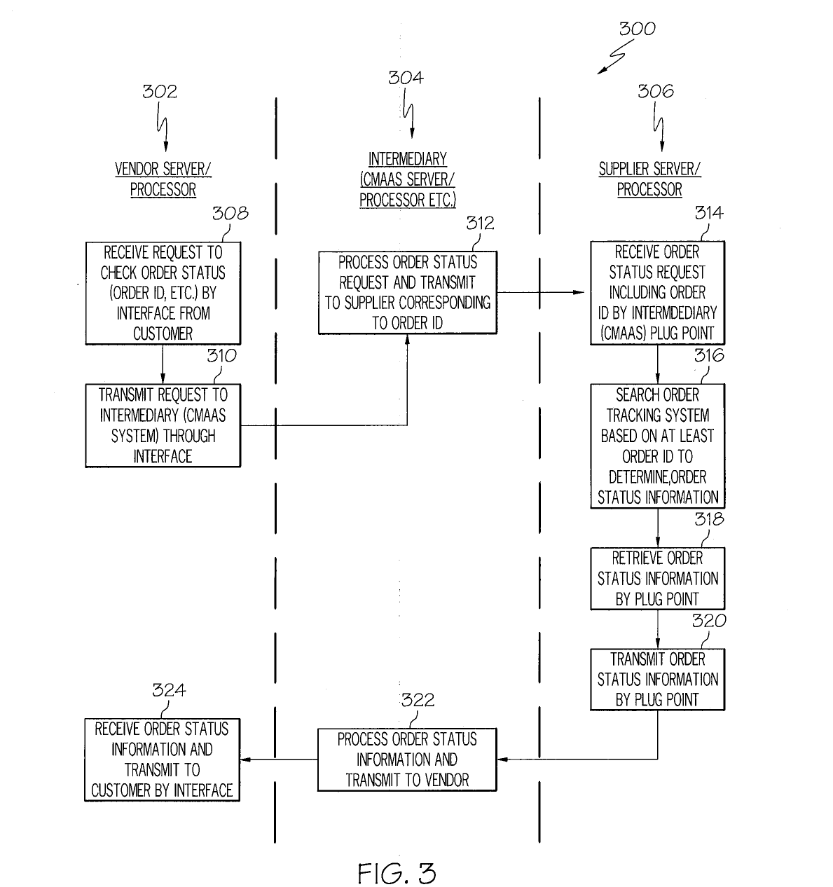

FIG. 3 is a flow chart of an example of a method 300 for monitoring a drop ship process in accordance with an embodiment of the present invention. The exemplary method 300 as shown in FIG. 3 is divided into operations which may embodied in and performed by a vendor server 302 or processor, an intermediary server 304 or processor, and a supplier server 306 or processor. The method 300 may be embodied in and performed by components of the system 100 and FIG. 1. For example, the vendor server 302 may be the same as the vendor server 102. The intermediary server 304 may be the same as intermediary 126, and the supplier server 306 may be the same as supplier server 112 in FIG. 1. The invention is not intended to be limited by any particular operation being described as being embodied in or performed by any particular server or processor in FIG. 3.

In block 308, a request to check a status of an order may be received by an interface of the vendor server 302 from a customer. The request to check the status of the order may include an order ID for indexing into the supplier order tracking system. In block 310, the request may be transmitted to the intermediary 304 by the interface. In block 312, the order status request may be processed by the intermediary 304 and transmitted to the supplier server 306.

In block 314, the order status request may be received by the supplier server 306. As previously discussed, the order status request may include an order ID. The order status request may be received at the supplier or supplier server 306 by a plug point or intermediary plug point similar to that previously described.

In block 316, an order tracking system and/or database may be searched based on at least the order ID to determine the status of the drop ship order. In block 318, the order status information may be retrieved by the plug point. In block 320, the order status information may be transmitted by the plug point to the intermediary 304. Location information of at least one of the drop ship order and the item in the supplier drop ship process may be determined. The location information may be retrieved and transmitted by the plug point to the interface associated with the vendor 302 through the intermediary 304.

In block 322, the order status information may be received and processed by the intermediary 304. The intermediary 304 transmits the order status information to the vendor.

In block 324, the order status information is received by the interface of the vendor 302. The interface then transmits the order status information to the customer.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for monitoring a drop ship process, comprising:
receiving, by a processor, a drop ship order for an item from a vendor, the item being ordered by a customer of the vendor;
performing, by the processor, a supplier drop ship process in response to receiving the drop ship order; and
providing a plug point associated with the supplier, the plug point being connectable through an intermediary to an interface, wherein the supplier drop ship process is monitorable through the interface.

2. The method of claim 1, further comprising allowing the customer to determine a status of the drop ship order through the interface.

3. The method of claim 2, further comprising:
determining location information of at least one of the drop ship order and the item in the supplier drop ship process; and
transmitting the location information by the plug point to the interface through the intermediary.

4. The method of claim 2, further comprising receiving a request for the status of the drop ship order, the request comprising at least an order ID.

5. The method of claim 4, further comprising receiving the order ID associated with the drop ship order from the vendor when the drop ship order is received.

6. The method of claim 4, further comprising:
generating the order ID by the supplier in response to receiving the drop ship order from the vendor;
associating the order ID with the drop ship order; and
transmitting the order ID to the vendor.

7. The method of claim 1, further comprising receiving a request for a status of the drop ship order by the plug point.

8. The method of claim 7, further comprising:
searching an order tracking system for the status of the drop ship order in response to receiving the request for the status of the drop ship order;
retrieving the status of the drop ship order by the plug point; and
transmitting the status of the order to the customer through the intermediary and the interface.

9. The method of claim 1, wherein the intermediary comprises a community management as a service system.

10. A method for monitoring a drop ship process, comprising:
receiving, by a processor, an order for an item from a customer;
determining, by the processor, if the order for the item is a drop ship order;
transmitting, by the processor, the drop ship order to a drop ship supplier in response to the order for the item being a drop ship order; and
providing an interface associated with the vendor, the interface being coupled by an intermediary to the drop ship supplier, wherein a drop ship process of the drop ship supplier is monitorable through the interface.

11. The method of claim 10, further comprising allowing the customer to determine a status of the drop ship order through the interface.

12. The method of claim 11, further comprising receiving by the interface a request for a status of the drop ship order, the request comprising at least an order ID associated with the drop ship order.

13. The method of claim 12, further comprising providing the order ID associated with the drop ship order to the customer.

14. The method of claim 13, further comprising:
generating the order ID associated with the drop ship order by the vendor; and
transmitting the order ID associated with the drop ship order to the supplier.

15. The method of claim 13, further comprising receiving the order ID associated with the drop ship order by the vendor from the supplier, wherein the supplier generates the order ID in response to receiving the drop ship order from the vendor.

16. The method of claim 10, further comprising:
receiving by the interface a request for a status of the drop ship order;
transmitting the request for the status of the drop ship order to the intermediary, wherein the intermediary transmits the request to the supplier; and
receiving the status of the drop ship order by the interface, the status of the drop ship order being transmitted to the interface by the supplier through the intermediary.

17. The method of claim 16, wherein the intermediary comprises a community management as a service system.

18. A system for monitoring a drop ship process, comprising:
a processor;
a module operating on the processor for receiving a drop ship order for an item from a vendor, the item being ordered by a customer of the vendor;
a module operating on the processor for performing a supplier drop ship process of a supplier in response to receiving the drop ship order; and
a plug point associated with the supplier, the plug point being connectable through an intermediary to an interface associated with the vendor, wherein the supplier drop ship process is monitorable through the plug point and the interface.

19. The system of claim 18, further comprising a module for determining location information of at least one of the drop ship order and the item in the supplier drop ship process in response to the plug point receiving a request for a status of the drop ship order, wherein the plug point transmits the location information to the interface.

20. The system of claim 19, wherein the request for the status of the drop ship order comprises an order ID.

21. The system of claim 20, further comprising:
a module to generate the order ID in response to receiving the drop ship order for the item and to associate the order ID with the drop ship order; and
a module to transmit the order ID to the vendor.

22. The system of claim 18, further comprising a drop ship order tracking system for tracking a status of the drop ship order, wherein the plug point retrieves the status of the drop ship order in response to receiving a request for the status of the drop ship order.

23. A computer program product for monitoring a drop ship process, the computer program product comprising:
a computer readable storage medium having computer readable program code embodied therewith, the computer readable program code comprising:
computer readable program code configured to receive an order for an item from a customer;
computer readable program code configured to determine if the order for the item is a drop ship order;
computer readable program code configured to transmit the drop ship order to a drop ship supplier in response to the order for the item being a drop ship order; and
computer readable program code configured to provide an interface associated with a vendor, the interface being coupled by an intermediary to the drop ship supplier, wherein a drop ship process of the drop ship supplier is monitorable through the interface.

24. The computer program product of claim 23, further comprising computer readable program code configured to allow the customer to determine a status of the drop ship order through the interface.
